(19) United States
(12) Patent Application Publication
(10) Pub. No.: US 2009/0037948 A1
(43) Pub. Date: Feb. 5, 2009

(54) MULTICAST TELEVISION SYSTEM

(75) Inventor: Tom Hostyn, Halle (BE)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Service Centre (Europe) N.V., Londerzeel (BE)

(21) Appl. No.: 12/185,431

(22) Filed: Aug. 4, 2008

(30) Foreign Application Priority Data
Aug. 3, 2007 (GB) 0715165.7

(51) Int. Cl. H04N 7/10

(52) U.S. Cl. 725/32

(57) ABSTRACT

A multicast television system including a server device and a plurality of user devices wherein a stream of data including television program data and advertisement data is multicast by the server device for reproduction by a plurality of user devices wherein, in the multicast stream of data, a period of advertisement data is provided together with marker data, the marker data indicating the length of the period. At individual respective user devices receiving the multicast stream of data, advertisement data stored locally at the respective user devices is selectively reproduced in place of the period of advertisement data provided in the multicast stream of data.

### CROSS-REFERENCE TO RELATED APPLICATIONS

This application is based upon and claims the benefit of priority from the prior British Patent Application No. 0715165.7, filed Aug. 3, 2007, the entire contents of which are incorporated herein by reference.

### BACKGROUND OF THE INVENTION

1. Field of the Invention

The present invention relates to a multicast television system, together with a server device and user device for use in the multicast television system and a method of providing television program data and advertisement data to a plurality of user devices.

2. Description of the Related Art

It has become well-known to provide audio/video data over networks, such as the internet, to a plurality of user devices connected to the network. Audio/video data may include television programs as well as advertisements included with the television programs by the service provider.

Multicast systems are known where a stream of data containing television programs and advertisements is provided over a network simultaneously to a plurality of user devices. With this arrangement, all user devices will receive the same advertisement. It is also known to provide a unicast arrangement, such are used for video-on-demand systems, where an individual user device requests a particular audio/video stream and this is provided for that user device by the server device. With such a unicast system it is possible for the server device to provide advertisements which are tailored to the user device, for instance tailored to the interests of the particular user of that user device.

### SUMMARY OF THE INVENTION

The present invention is based at least partly on a recognition of the desirability of being able to multicast a television program to a plurality user devices simultaneously and the conflicting desirability of being able to tailor particular advertisements received by an end user to the usage of individual respective user devices.

According to the present invention, there is provided a method of providing television program data and advertisement data to a plurality of user devices. The method includes multicasting a stream of data including television program data and advertisement data for reproduction by a plurality of user devices. In the multicast stream of data, a period of advertisement data is provided together with marker data, the marker data indicating the length of the period. The method includes selectively reproducing, at individual respective user devices receiving the multicast stream of data, advertisement data stored locally at the respective user devices in place of the period of advertisement data provided in the multicast stream of data.

According to the present invention, there is also provided a server device for use in a multicast television system with a plurality of user devices. The server device is configured to multicast a stream of data to a plurality of user devices, the multicast stream of data including television program data and advertisement data for reproduction by the plurality of user devices. The server device is also configured to provide in the multicast stream of data, a period of advertisement data together with marker data, the marker data indicating the length of the period such that individual respective user devices receiving the multicast stream of data can selectively reproduce advertisement data stored locally at the respective user devices in place of the period of advertisement data provided in the multicast stream of data.

According to the present invention, there is also provided a user device for use in a multicast television system with a server device. The user device is configured to receive from the server device a multicast stream of data including television program data and advertisement data for reproduction by a plurality of user devices, the multicast stream of data being provided with a period of advertisement data together with marker data, the marker data indicating the length of the period. The user device receiving the multicast stream of data is configured to selectively reproduce advertisement data stored locally at the user device in place of the period of advertisement data provided in the multicast stream of data.

In this respect, there will normally be a plurality of user devices, such that the present invention also provides a multicast television system including the server device and a plurality of the user devices.

In this way, although the advantages of a multicast system are provided in transmitting a single stream of data simultaneously to a plurality of user devices, individual respective user devices are still able to reproduce advertisements on an individual basis and more like a unicast type system.

The method further includes providing, in the multicast stream of data, another period of advertisement data and reproducing, at all user devices receiving the multicast stream of data, the advertisement data of the another period of advertisement data. Thus, the server device can be configured to provide, in the multicast stream of data, another period of advertisement data such that all user devices receiving the multicast stream of data reproduce the advertisement data of the another period of advertisement data. Similarly, all user devices, receiving the multicast stream of data, can be configured to reproduce the advertisement data of the another period of advertisement data.

In this way, it is possible also merely to multicast some advertisement data to all user devices.

The method includes storing locally at respective user devices the advertisement data provided in the another period of advertisement data. Thus, respective user devices can be configured to store locally the advertisement data provided in the another period of advertisement data.

In this way, when marker data is detected and a user device reproduces stored advertisement data in place of that received in the period of advertisement data, the user device can reproduce advertisement data which has been stored previously from an earlier multicast. Multicast advertisement data might be of limited interest to user devices at a whole, but of particular interest to some user devices. Hence, it may be desirable for some user devices to repeat this previously multicast advertisement data more often.

Preferably, the method includes storing locally at respective user devices the advertisement data provided in the period of advertisement data whilst reproducing the advertisement data stored locally in place of the period of advertisement data. Thus, respective user devices can be configured to store locally the advertisement data provided in the period of advertisement data whilst reproducing the advertisement data stored locally in place of the period of advertisement data.

In this way, respective user devices can obtain and store advertisement data received during the period of advertisement data and keep it for possible future use during other periods of advertisement data. For instance, not all of the advertisement data received within a given period may be appropriate for a particular respective user device. During subsequent periods of advertisement data, an individual respective user device could reproduce only those appropriate parts of previously stored advertisement data. By storing received advertisement data during the period of advertisement data, maximum use is made of the bandwidth and data transmitted over the network.

Preferably, the method includes storing locally at user devices respective user profile data indicative of usage of the respective user devices and reproducing selectively at user devices advertisement data according to the user profile data of the respective user devices. Thus, the user devices are preferably configured to store locally respective user profile data indicative of usage of the respective user devices and the user devices are configured to reproduce selectively advertisement data according to the user profile data of the respective user devices.

In this way, profile data is stored to keep a representation of the user profile of usage of a particular respective user device. Then, irrespective of what advertisement data has been stored previously locally at an individual respective user device, that individual respective user device can choose to reproduce, from previously stored advertisement data, only advertisement data appropriate for the user profile of the respective user device.

Preferably, the method includes providing metadata with the advertisement data, the meta including one or more qualities of the advertisement data. In this respect, the server device can be configured to provide metadata with the advertisement data. Preferably, the method includes selecting advertisement data for reproduction at respective user devices by comparing the metadata of advertisement data stored at the respective user devices with the user profile data stored at respective user devices. Thus, respective user devices can be configured to select advertisement data for reproduction by comparing the metadata of advertisement data stored at respective user devices with the user profile stored at the respective user devices.

In this way, individual respective user devices can decide whether or not to reproduce previously stored advertisement data merely by comparing the metadata of the previously stored advertisement data with the user profile data stored at the respective user devices.

Preferably, the method includes selectively storing locally at respective user devices, according the user profile data of the respective user devices, the advertisement data provided in the another period of advertisement data. Thus, respective user devices can be configured to selectively store locally, according to the user profile data of the respective user devices, the advertisement data provided in the another period of advertisement data.

In this way, individual respective user devices need not store all advertisement data provided in the multicast transmission in the another period of advertisement data. Instead, by considering the user profile for an individual respective user device, that individual respective user device can decide whether or not it is appropriate to store advertisement data in the another period of advertisement data.

Preferably, the method includes selectively storing locally at respective user devices, according to the user profile data of the respective user devices, the advertisement data provided in the period of advertisement data. Thus, respective user devices can be configured to selectively store locally, according to the user profile data of the respective user devices, the advertisement data provided in the period of advertisement data.

Thus, user devices can similarly decide whether or not it is appropriate to store advertisement data provided in the period of advertisement data according to the user profile of the respective user devices.

Preferably, the method includes deciding whether or not to store advertisement data locally at respective user devices by comparing the metadata of the advertisement data with the user profile data stored at the respective user devices. Thus, respective user devices can be configured to decide whether or not to store advertisement data locally by comparing the metadata of the advertisement data with the user profile data stored at the respective user devices.

This provides a convenient way for user devices to decide whether advertisement data is appropriate for the user profile of a respective user device.

Preferably, the method includes using, at the individual respective user devices, the marker data so as to reproduce advertisement data stored locally at the respective user device for the length of the period indicated by the marker data. Thus, individual respective user devices can be configured to use the marker data so as to reproduce the advertisement data stored locally at the respective user devices for the length of the period indicated by the marker data.

In this way, the length of the period can be compared with the lengths or durations of blocks of advertisement data stored locally. It is possible then to choose only blocks of advertisement data of appropriate length/duration for reproduction or to modify the length/durations of blocks of advertisement data as necessary.

According to the present invention, there is also provided a method for generating advertising revenue. Television data is broadcast and this is interspersed with first advertising data to user devices in communication with a broadcast network, at least some of the user devices being configured to capture said first advertising data. The television data is further interspersed with second advertising data broadcast to the said at least some user devices, the at least some user devices being configured to substitute the second advertising data with said captured first advertising data according to respective user profile data for the user devices. Messages are communicated indicating selection and/or replay of the captured first advertising data for the user devices. Advertising revenue is collected based on information derived from said messages and corresponding to a number of selection and/or replay instances of the captured first advertising data.

The present invention may also be embodied as a computer program comprising program code means or be embodied as a computer program product comprising program code means stored on a computer readable medium for performing the steps conducted by the server device and/or the steps performed by a user device.

### BRIEF DESCRIPTION OF THE DRAWINGS

A more complete appreciation of the embodiments described herein and many of the attendant advantages thereof will be readily obtained as the same becomes better understood by reference to the following detailed description when considered in connection with the accompanying drawings, wherein:

FIG. 1 illustrates a network in which the present invention may be embodied;

FIG. 2 illustrates a server device embodying the present invention;

FIG. 3 illustrates a multicast stream of data produced according to an embodiment of the present invention;

FIG. 4 illustrates a user device embodying the present invention;

FIG. 5 illustrates a user device connected to a database.

### DETAILED DESCRIPTION OF THE PREFERRED EMBODIMENTS

The invention will be more clearly understood from the following description, given by way of example only with reference to the accompanying drawings.

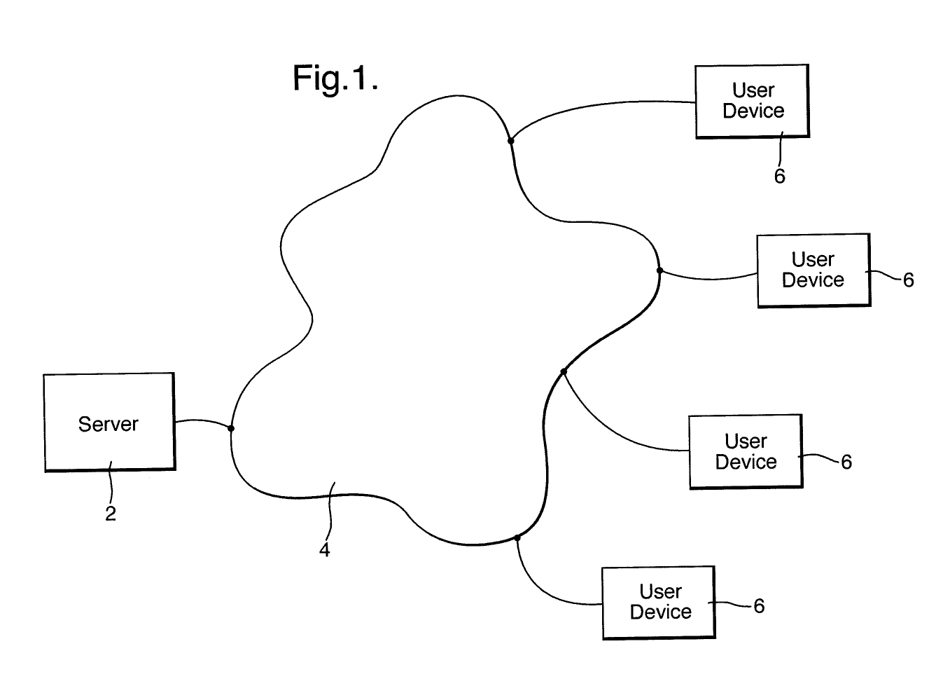

Networks, such as the internet, allow audio/video information to be provided from a server device to a plurality of user devices. As illustrated schematically in FIG. 1, a server device 2 is connected to a network 4, such as the internet. A plurality of user devices 6 are similarly connected to the network 4. The user devices 6 can be considered as clients and include for example internet protocol television set top boxes, personal computer video players etc. They are configured to receive internet protocol video transmissions from the network 4. These transmissions can be multicast. In this case, the server device 2 provides audio/video data according to an internet protocol on the network 4 for simultaneous reception by a plurality of the user devices 6. Alternatively or additionally, unicast transmissions are possible whereby an individual user device 6 requests an audio/video transmission from the server device 2 and the server device 2 provides the requested audio/video information in an internet protocol on the network 4 for reception by the user device 6 that requested it.

Internet protocol multicast allows one IP (internet protocol) host, such as the server device 2, to send data to any number of other hosts, e.g. the user devices 6, simultaneously. In this case video streaming hardware can send a video broadcast to millions of user devices at once. The multicast technology makes very efficient use of the network equipment and is therefore very scalable. All user devices will receive the same content and, for the user device, the experience can best be compared to traditional analog cable TV, digital video satellite, cable or terrestrial broadcasts in the sense that the video content is sent to all viewers and all viewers watch the same content at the same time.

In contrast, IP unicast (TCP or UDP) allows one IP host, e.g. the server device 2, to send data to a single other IP host, e.g. an individual user device 6. This type of communication is typically used for web server access and, in the context of a video or IP system, can be used to watch on-demand content or to use network PVR (personal video recorder) functions.

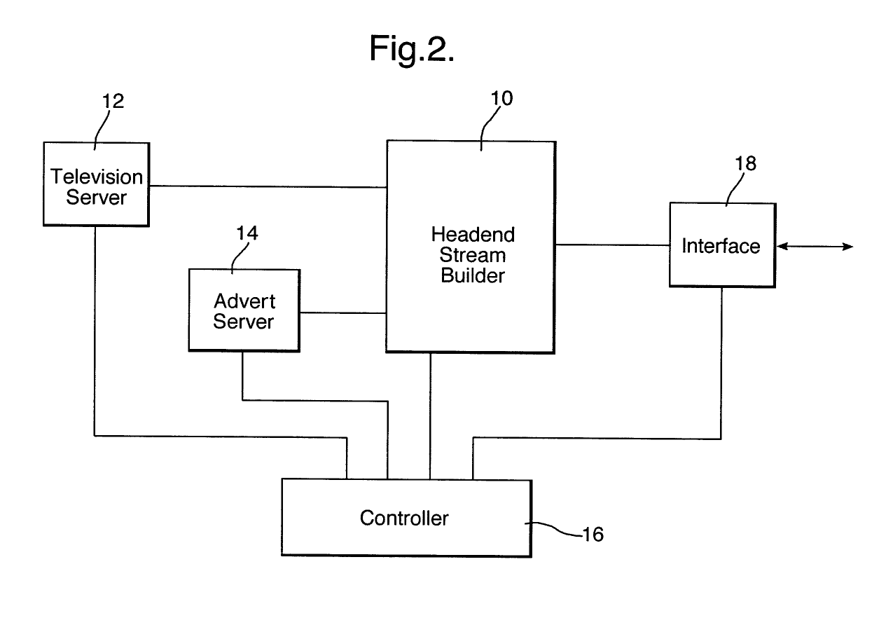

FIG. 2 illustrates schematically an example of a server device 2.

As illustrated, the server device 2 includes a head end stream builder 10 configured to build a stream of data conforming to internet protocol standards. The server device also includes a television server 12 for providing television program data and an advertisement server 14 for providing advertisement data. Both the television program data and the advertisement data are preferably in the form of audio-video data for reproduction as audio-video by user devices 6.

Under the control of a controller 16, the head end stream builder 10 is configured to build a stream of data including television program data from the television server 12 and advertisement data from the advertisement server 14 and to provide this stream to an interface 18 for transmission on the network 4 described above with reference to FIG. 1.

The present application is particularly concerned with the situation where the head end stream builder 10 provides, via the interface 18, a multicast stream of data on the network 4 for reception simultaneously by all user devices 6.

The controller 16 is configured to control the television server 12, advertisement server 14 and head end stream builder 10 to provide a stream of data which includes a plurality of periods of television program data interspersed with advertisement data. In this way, user devices 6 reproduce television programs in a traditional manner interspersed with advertisements.

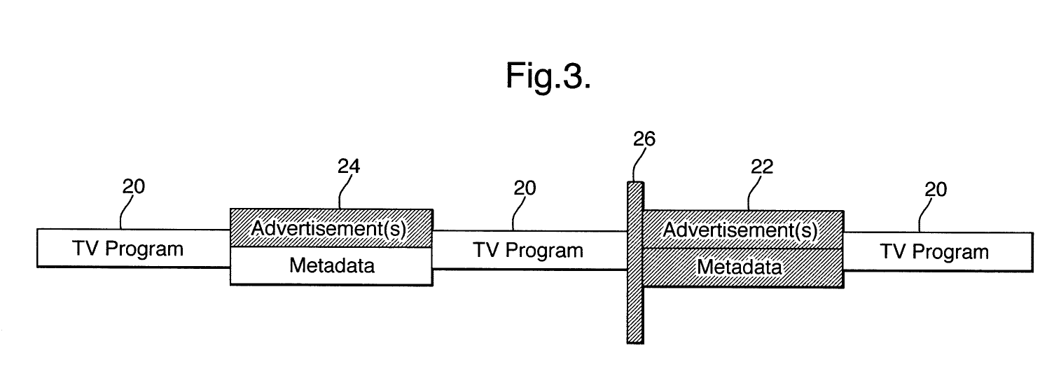

FIG. 3 illustrates schematically one part of a typical stream produced by the head end stream builder 10 including features embodying the present invention.

As illustrated, sections of television program data 20 are interspersed with sections of advertisement data 22 and 24.

A period 22 of advertisement data is accompanied by marker data 26. In the illustrated embodiment, the marker data 26 is provided in its own section provided immediately before the period 22 of advertisement data. However, it would also be possible to provide this marker data earlier on in the overall stream of data. The marker data could still be provided in its own section or could be embedded with other data, such as earlier television program data or advertisement data.

The marker data provides information indicating the length of the period 22 of advertisement data. In other words, it specifies the duration of the advertisement data. When the marker data 26 is provided in its own section immediately preceding the period 22 of advertisement data, it implicitly indicates the start of the period 22 of advertisement data. Where the marker data 26 is provided earlier in the overall stream of data, it could include other information indicating the start of the period 22 of advertisement data.

By virtue of the marker data 26, it is possible for user devices 6 to determine when and for how long the period 22 of advertisement data occurs in the overall stream of data. As will be described below, this allows user devices 6 to reproduce some other data in place of the advertisement data contained in the period 22.

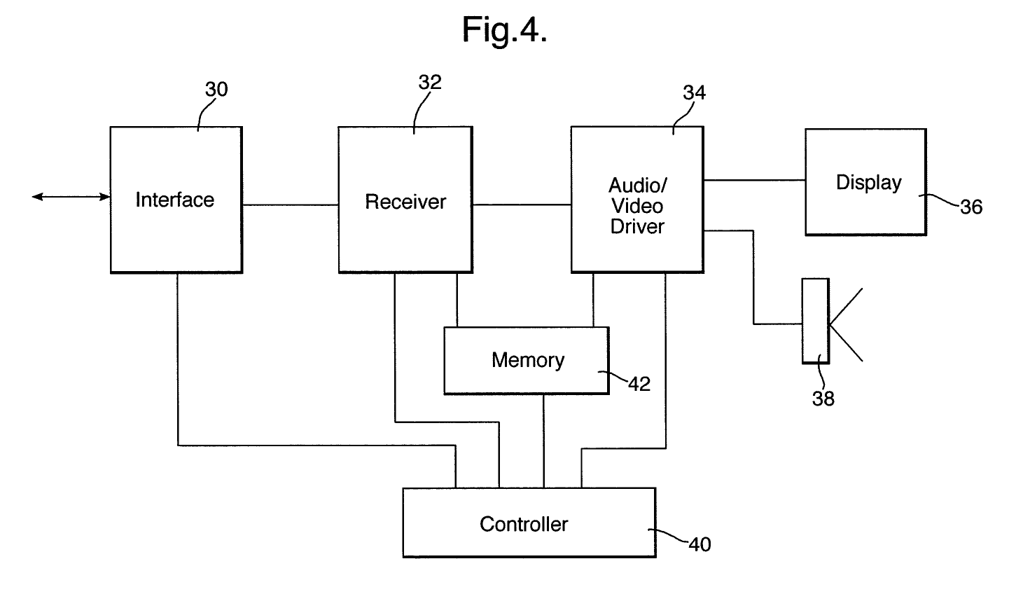

FIG. 4 illustrates an example of a user device 6.

An interface 30 connects the user device 6 to, for example, the network 4 of FIG. 1. A receiver 32 receives, via the interface 30, a stream of data received over the network 4, such as the stream illustrated in FIG. 3. Television program data contained in sections 20 can be decoded as necessary and passed to on audio-video drive 34 for reproduction by means of a display 36 and one or more loudspeakers 38. A controller 40 is configured to control various components of the user device accordingly.

In the normal course, advertisement data in the form of audio-video data would be passed to the audio-video driver 34 in the same manner as television program data and reproduced in the manner of traditional television where all end users receive and display the same advertisements between television programs. However, the illustrated embodiment of FIG. 4 includes a receiver 32 and controller 40 configured to detect the marker data 26 provided in the overall stream of data of FIG. 3. The user device is provided with a memory 42, such as a hard disc drive (HDD). This can include stored therein alternative advertisement data. Thus, in the illustrated embodiment, the controller 40 is configured to respond to receipt of the marker data 26 and to control the audio-video driver 34 to reproduce advertisement data stored in the memory 42 in place of the advertisement data received in the period 22. The marker data 26 provides an indication of the length of the period 22 such that the controller 40 can ensure that the audio-video driver 34 only reproduces advertisement data from the memory 42 for the appropriate length or duration such that the received television program data is reproduced at the end of the period 22. Preferably, the controller 40 controls the audio-video driver 34 to reproduce a block of advertisement data stored in the memory 42 having an appropriate duration. However, it is also possible for the controller 40 to implement some appropriate routine to adjust the length of a block of advertisement data stored in the memory 42 to have the appropriate duration.

By virtue of this arrangement, the system allows a user device to reproduce advertisements in a manner perceived by users as unicast, even though the overall transmission is multicast.

The advertisements reproduced from memory 42 are preferably chosen to be suitable for the viewing habits of the user of the user device.

The controller 40 is preferably configured to monitor usage of the user device, in particular the types of television program that the user device reproduces. Profile data representing this usage can be stored in another area of the memory 42 or in a separate memory. By referring to this profile data, the controller 40 can decide which advertisement data should be reproduced in place of the advertisement data received in the period 22. In this respect, the advertisement data stored in the memory 42 is preferably stored in conjunction with metadata which provides information relating to the advertisement data, in particular indicating the nature of the advertisement data, for instance the subject matter to which it relates. Thus, if the profile data stored for a particular user device indicates that that user device is used to reproduce a lot of a particular type of television program, such as a sporting program, the controller 40 can refer to the metadata stored in association with the advertisement data in memory 42 to choose advertisement data which is appropriate for a user having a sporting interest.

Thus, although a multicast stream of data is provided over the network 4 and received by all user devices 6, by virtue of the marker data 26, individual respective user devices 6 can choose to reproduce advertisement data in place of the advertisement data provided in the period 22 and more appropriate to the usage habits of the user device 6.

The advertisement data stored in memory 42 can have been provided in one or more of a number of different ways. A user device 6 can be supplied from new pre-loaded with advertisement data. Also, advertisement data could be provided to the user device 6 by means of other channels, for instance using memory devices such as optical discs or by reception over different channels on the network 4.

In some embodiments, these may be unicast to a receiver device. Unicasting may be considered to be a “push” mechanism in which advertisement is “pushed” from a server to a receiver device. A user of a receiver device may also choose to download advertisement data from a network-connected server which maybe considered a “pull” mechanism.

According to one preferred embodiment, while the audio-video driver 34 is reproducing advertisement data from the memory 42 during the period 22, the receiver 32 is able to store the advertisement data received during the period 22 in the memory 42. In this way, the advertisement data received during the period 22 can be used in the future during other similar periods 22.

It will be appreciated that multicast advertisement data received during the period 22 for retrieval in accordance with a user profile may be supplemented by one or more of unicast advertisement data, downloaded advertisement data, pre-loaded advertisement data and advertisement data provided on a data carrier.

As illustrated schematically in FIG. 3, the advertisement data is preferably provided with metadata as described above providing information regarding the nature of the advertisement data. The controller 40 of the user device 6 can be configured to control the received 32 to store in the memory 42 only advertisement data which is appropriate for the user profile of the user device 6. For instance, the metadata of the advertisement data received in the period 22 can be compared with the profile data stored for the user device 6 and the controller 40 can decide whether or not the receiver 32 should store the advertisement data on the basis of that comparison. On the other hand, the user device 6 can be configured to store all the advertisement data received during the period 22 irrespective of its nature. Thus, in some embodiments, the memory 42 will only have stored therein advertisement data appropriate for reproduction by that particular user device, whereas other embodiments will have stored in the memory 42 advertisement data of all types and natures.

Where the memory 42 stores all types and natures of advertisement data, the controller 40 is preferably configured to refer to the metadata associated with the stored advertisement data and compare this to the user profile, for instance by comparison to the stored profile data, so as to choose appropriate advertisement data for reproduction by the audio-video driver 34. In some embodiments, this comparison and selection may also be applied even where the intention had been to store only advertisement data appropriate for the user profile of the particular user device 6. This is advantageous in that it takes account of the possibility of a user profile changing over time. In some embodiments there may be more than one user profile for the devices, e.g. one separate profile for each user or member of a household.

Advertisements may be tagged and transmitted with accompanying textual metadata. Such metadata may describe a genre or type of product or service advertised such as automotive vehicles, soft drinks, alcoholic beverages, travel agents, postal/courier services, movies, etc. In other embodiments, metadata may describe a particular suitability for a particular kind of viewer, such as children, adolescents, men, women, etc. (i.e. a demographic category). In this way, it is possible to detect and prevent the insertion of, for example, advertisements for alcoholic beverages being inserted during programs for children. In some embodiments, advertisements for alcoholic beverages might only be inserted when the receiver is used at an appropriate time of day such as between 9 pm and 4 am. The time may be determined from a local clock in the receiver, a time signal broadcast periodically or concurrently with the television signals, or indeed a time signal provided to the receiver from the internet or other such network. Metadata may include one or more representative video/still image keystamps which may best represent the content of the advertisement. In some embodiments, ground truth metadata may be used. Ground truth metadata differs from textual metadata or keystamps in that it is derived directly from the audio/video data. In one example, such metadata would be data representing the colour properties of the advertisement data. Colour properties may be expressed and/or stored as a feature vector. These colour properties may be derived from an entire portion of the advertisement data or from a representative keystamp. A processor and/or software may operate on the stored profile data to find appropriate advertisement data according to the ground truth metadata. In this way, a user may be able to select advertisement data as particularly suitable and store it or its representation in the profile data such that similar advertisements as identified by metadata/ground truth metadata are retrieved and displayed at a later time.

Referring again to FIG. 3, there is illustrated the possibility of the server device 2 providing additional blocks 24 of advertisement data without associated marker data. In the absence of such marker data, a user device 6 will merely pass the advertisement data to its respective audio-video driver for reproduction. Hence, the advertisement data provided in period 24 will be multicast and reproduced by all user devices 6.

In the illustrated embodiment, the advertisement data of period 24 is provided with metadata as described above. In one embodiment, the controller 40 of respective user devices 6 can be configured to control the receiver 32 to store the advertisement data of the period 24 in the memory 42 at the same time as this data being passed to the audio-video driver 34 for reproduction. Thus, even though the advertisement data in the period 24 is being multicast to all user devices 6 and reproduced by all user devices 6, it can simultaneously be stored in respective user devices 6 for possible future reproduction also.

In the same manner as described above, the controller 40 can be configured to selectively store advertisement data from the period 24 according to a comparison between the metadata of that advertisement data and the user profile of the respective user device 6.

On the other hand, once the receiver 32 has stored in memory 42 advertisement data received during a period 24, subsequent reproduction of that advertisement data from memory 42 can be determined by controller 40 in the same way as described above. In particular, in some embodiments, it may be known that all advertisement data stored in memory 42 is appropriate for the user profile of the respective user device 6. In other embodiments, the controller 40 may be configured to compare the metadata of the advertisement data stored in the memory 42 with the user profile, for instance by means of the profile data, in order to select appropriate advertisement data for reproduction.

By means of the arrangement described above, it is possible to provide both fixed adverts, by means of periods 24, where all viewers watch the same adverts, as well as personalised advertising, by means of the periods 22. The pool of advertisements from which to choose the personalised advertisements can be taken from one, the other or both of the advertisements provided during the fixed advertisement periods and the advertisements provided during the personalised advertisement periods.

Advertising rates for broadcasting advertisements to all viewers are typically set by negotiation between advertising and broadcaster. Such rates may be dependent upon expected viewing figures for the broadcast television program and the duration of the advertisement. Advertising rates for advertisements delivered to specific users based on their profile data (i.e. interests) may be higher as there is a higher probability that they will be watched with a viewer actually paying attention and influence purchasing decisions of a user. Thus, in the context of the present invention, there is a need to inform the broadcaster or other authority if an advertisement is chosen from memory 42 according to the viewing habits (profile data) of the user, such that the broadcaster is appropriately remunerated for the reproduced advertisement. In some embodiments, none, some or all of the remuneration may be paid to a user equipment supplier or manufacturer or software provider which has provided the functionality for reproducing advertisement according to user profile data.

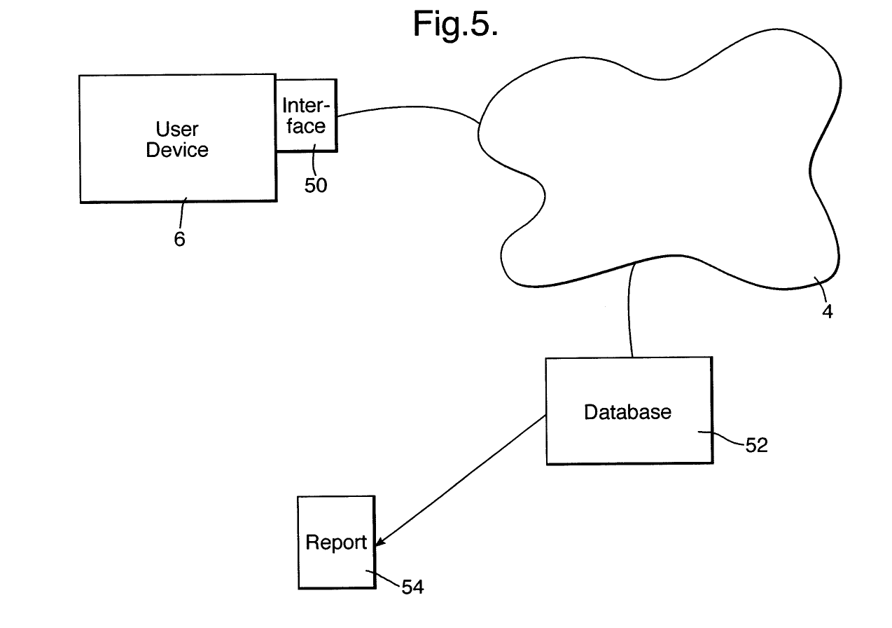

Therefore, as shown in FIG. 5, the user equipment may be provided with an interface 50 to a communications network, such as the Internet 4. The user equipment may be connected to a database 52 by means of the communications network and be arranged to communicate messages representing selection and/or playback of an advertisement selected or reproduced according to the user profile. The advertisements may be provided with identification data, or identification data may be derived from the advertisement data itself using, for example, a signature representing characteristics of the advertisement data. In other embodiments, different digital watermarks representing identification data may be embedded in the advertisements and decoded by the user device. The identification data would be communicated to the database 52 together with an indication of the number of selections and/or replays of that advertisement in the message. Additional data may be communicated in the message, such as identification data for the user equipment or time/date data.

The database 52 may be configured to output reports 54 on a total number of selections/replays by all or groups of user devices and to generate invoices to respective advertisers or agencies.

As mentioned the database 52 may be operated by or on behalf of the broadcaster, but in other embodiments the database may be operated by or on behalf of the television network provider, supplier or manufacturer of user devices or by a manufacturer of software running on the user devices.

A device according to an embodiment of the present invention may also include at least one computer readable medium or memory for holding instructions programmed according to the teachings of the invention and for containing data structures, tables, records, or other data described herein. Examples of computer readable media suitable for the present invention are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Such computer readable media further includes a computer program product of the present invention for performing the inventive method herein disclosed. The computer code devices of the present invention can be any interpreted or executable code mechanism, including but not limited to, scripts, interpreters, dynamic link libraries, Java classes, and complete executable programs.

Having now fully described non-limiting embodiments of the present amendment, it will be apparent to one of ordinary skill in the art that many changes and modifications can be made thereto without departing from the spirit and scope of the advancement as set forth therein.

We claim:

1. A method of providing television program data and advertisement data to a plurality of user devices, the method comprising:
multicasting a stream of data including television program data and advertisement data for reproduction by a plurality of user devices;
providing, in the multicast stream of data, a period of advertisement data together with marker data, the marker data indicating the length of the period;
selectively reproducing, at individual respective user devices receiving the multicast stream of data, advertisement data stored locally at the respective user devices in place of the period of advertisement data provided in the multicast stream of data;
providing, in the multicast stream of data, another period of advertisement data;
reproducing, at all user devices receiving the multicast stream of data, the advertisement data of the another period of advertisement data; and
storing locally at respective user devices the advertisement data provided in the another period of advertisement data.

2. A method according to claim 1 further comprising:
storing locally at respective user devices the advertisement data provided in the period of advertisement data whilst reproducing the advertisement data stored locally in place of the period of advertisement data.

3. A method according to claim 1 further comprising:
storing locally at user devices respective user profile data indicative of usage of the respective user devices; and
reproducing selectively at user devices advertisement data according to the user profile data of the respective user devices.

4. A method according to claim 3 further comprising:
providing metadata with the advertisement data, the metadata indicating one or more qualities of the advertisement data; and
selecting advertisement data for reproduction at respective user devices by comparing the metadata of advertisement data stored at the respective user devices with the user profile data stored at the respective user devices.

5. A method according to claim 1 further comprising:
storing locally at user devices respective user profile data indicative of usage of the respective user devices; and
selectively storing locally at respective user devices, according to the user profile data of the respective user devices, the advertisement data provided in the another period of advertisement data.

6. A method according to claim 1 further comprising:
storing locally at user devices respective user profile data indicative of usage of the respective user devices; and
selectively storing locally at respective user devices, according to the user profile data of the respective user devices, the advertisement data provided in the period of advertisement data.

7. A method according to claim 5 or 6 further comprising:
providing metadata with advertisement data, the metadata indicating one or more qualities of the advertisement data; and
deciding whether or not to store advertisement data locally at respective user devices by comparing the metadata of the advertisement data with the user profile data stored at the respective user devices.

8. A method according to claim 1 further comprising:
using, at the individual respective user devices, the marker data so as to reproduce the advertisement data stored locally at the respective user devices for the length of the period indicated by the marker data.

9. A method according to claim 1 further comprising:
at least one of: storing locally at the respective user devices unicast advertisement data transmitted to the respective user devices, downloading advertisement data at respective user devices and storing the downloaded advertisement data locally at the respective user devices, and storing locally at respective user devices pre-loaded advertisement data; and
supplementing the selectively reproduced advertisement data with at least one of the unicast advertisement data, the downloaded advertisement data, the pre-loaded advertisement data and advertisement data provided on a data carrier.

10. A server device for use in a multicast television system with a plurality of user devices, wherein:
the server device is configured to multicast a stream of data to a plurality of user devices, the multicast stream of data including television program data and advertisement data for reproduction by the plurality of user devices;
the server device is configured to provide in the multicast stream of data, a period of advertisement data together with marker data, the marker data indicating the length of the period such that individual respective user devices receiving the multicast stream of data can selectively reproduce advertisement data stored locally at the respective user devices in place of the period of advertisement data provided in the multicast stream of data; and
the server device is configured to provide, in the multicast stream of data, another period of advertisement data such that all user devices receiving the multicast stream of data reproduce the advertisement data of the another period of advertisement data.

11. A server device according to claim 10 wherein:
the server device is configured to provide metadata with the advertisement data, the metadata indicating one or more qualities of the advertisement data.

12. A user device for use in a multicast television system with a server device wherein:
the user device is configured to receive from the server device a multicast stream of data including television program data and advertisement data for reproduction by a plurality of user devices, the multicast stream of data being provided with a period of advertisement data together with marker data, the marker data indicating the length of the period;
the user device receiving the multicast stream of data is configured to selectively reproduce advertisement data stored locally at the user device in place of the period of advertisement data provided in the multicast stream of data;
the multicast stream of data is provided with another period of advertisement data;
the user device, receiving the multicast stream of data, is configured to reproduce the advertisement data of the another period of advertisement data; and
the user device is configured to store locally the advertisement data provided in the another period of advertisement data.

13. A user device according to claim 12 wherein:
the user device is configured to store locally the advertisement data provided in the period of advertisement data whilst reproducing the advertisement data stored locally in place of the period of advertisement data.

14. A user device according to claim 12 wherein:
the user device is configured to store locally respective user profile data indicative of usage of the user device; and
the user device is configured to reproduce selectively advertisement data according to the user profile data of the respective user device.

15. A user device according to claim 14 wherein:
metadata is provided with the advertisement data indicating one or more qualities of the advertisement data; and
the user device is configured to select advertisement data for reproduction by comparing the metadata of advertisement data stored at the user device with the user profile data stored at the user device.

16. A user device according to claim 12 wherein:
the user device is configured to store locally respective user profile data indicative of usage of the user device; and
the user device is configured to selectively store locally, according to the user profile data of the user device, the advertisement data provided in the another period of advertisement data.

17. A user device according to claim 12 wherein:
the user device is configured to store locally respective user profile data indicative of usage of the user device; and
the user device is configured to selectively store locally, according to the user profile data of the user device, the advertisement data provided in the period of advertisement data.

18. A user device according to claim 16 wherein:
metadata is provided with the advertisement data indicating one or more qualities of the advertisement data; and
the user device is configured to decide whether or not to store advertisement data locally by comparing the metadata of the advertisement data with the user profile data stored at the user device.

19. A user device according to claim 12 wherein:
the user device is configured to use the marker data so as to reproduce the advertisement data stored locally at the user device for the length of the period indicated by the marker data.

20. A user device according to claim 12 wherein:
the user device is configured to one or more of: store locally unicast advertisement data transmitted to the respective user device; download advertisement data and store locally the downloaded advertisement data; and store locally pre-loaded advertisement data; and
the user device is configured to supplement the selectively reproduced advertisement data with one or more of the unicast advertisement data, the downloaded advertisement data, the pre-loaded advertisement data and advertisement data provided on a data carrier.

21. A multicast television system including:
a server device; and
a plurality of user devices; wherein
the server device is configured to multicast a stream of data to the plurality of user devices, the multicast stream of data including television program data and advertisement data for reproduction by the plurality of user devices;
the server device is configured to provide in the multicast stream of data, a period of advertisement data together with marker data, the marker data indicating the length of the period such that individual respective user devices receiving the multicast stream of data can selectively reproduce advertisement data stored locally at the respective user devices in place of the period of advertisement data provided in the multicast stream of data;
the server device is configured to provide, in the multicast stream of data, another period of advertisement data such that all user devices receiving the multicast stream of data reproduce the advertisement data of the another period of advertisement data;
each user device is configured to receive from the server device the multicast stream of data including television program data and advertisement data for reproduction;
each user device receiving the multicast stream of data is configured to selectively reproduce advertisement data stored locally at the respective user device in place of the period of advertisement data provided in the multicast stream of data;
each user device, receiving the multicast stream of data, is configured to reproduce the advertisement data of the another period of advertisement data; and
each user device is configured to store locally the advertisement data provided in the another period of advertisement data.

22. A computer readable storage medium encoded with computer executable instructions, which when executed by a computer, cause the computer to perform a method comprising:
multicasting a stream of data including television program data and advertisement data for reproduction by a plurality of user devices;
providing, in the multicast stream of data, a period of advertisement data together with marker data, the marker data indicating the length of the period;
selectively reproducing, at individual respective user devices receiving the multicast stream of data, advertisement data stored locally at the respective user devices in place of the period of advertisement data provided in the multicast stream of data;
providing, in the multicast stream of data, another period of advertisement data;
reproducing, at all user devices receiving the multicast stream of data, the advertisement data of the another period of advertisement data; and
storing locally at respective user devices the advertisement data provided in the another period of advertisement data.

23. A method for generating advertising revenue comprising:
broadcasting television data interspersed with first advertising data to user devices in communication with a broadcast network, at least some of the user devices being configured to capture said first advertising data;
broadcasting further television data interspersed with second advertising data to the said at least some user devices, the at least some user devices being configured to substitute the second advertising data with said captured first advertising data according to respective user profile data for the user devices;
communicating messages indicating selection and/or replay of the captured first advertising data for the user devices;
collecting advertising revenue based on information derived from said messages and corresponding to a number of selection and/or replay instances of the captured first advertising data.
